(19) United States
(12) Patent Application Publication
(10) Pub. No.: US 2024/0296324 A1
(43) Pub. Date: Sep. 5, 2024

(54) DIRECTED GRAPH AUTOENCODER DEVICES AND METHODS

(71) Applicant: INTERNATIONAL BUSINESS MACHINES CORPORATION, ARMONK, NY (US)

(72) Inventors: Georgios Kollias, White Plains, NY (US); Vasileios Kalantzis, White Plains, NY (US); Tsuyoshi Ide, Harrison, NY (US); Aurelie Chloe Lozano, Scarsdale, NY (US); Naoki Abe, Rye, NY (US)

(21) Appl. No.: 18/356,958

(22) Filed: Jul. 21, 2023

(30) Foreign Application Priority Data
Feb. 22, 2023 (GR) 20230100154

(51) Int. Cl. G06N 3/08

(52) U.S. Cl. CPC G06N 3/08

(57) ABSTRACT

A directed graph autoencoder device includes one or more memories and a processor coupled to the one or more memories and configured to implement a graph convolutional layer. The graph convolutional layer comprises a plurality of nodes and is configured to generate transformed dual vector representations by applying a source weight matrix and a target weight matrix to input dual vector representations of the plurality of nodes. The input dual vector representations comprise, for each node of the plurality of nodes, a source vector representation that corresponds to the node in its role as a source and a target vector representation that corresponds to the node in its role as a target. The graph convolutional layer is further configured to scale the transformed dual vector representations to generate scaled transformed dual vector representations. The graph convolutional layer is further configured to perform message passing using the scaled transformed dual vector representations.

### BACKGROUND

Graph-structured data are ubiquitous and used in diverse domains ranging from biochemical interaction networks to networks of social and economic transactions. A graph introduces dependencies between its connected nodes. Thus, algorithms designed to work solely with feature vectors of isolated nodes as inputs can yield suboptimal results. One way to remedy this issue is to enhance the representation of a graph node so that both its features and embedding graph structure are captured in a single vector.

Graph Convolutional Networks (GCNs) produce vectoral representations of nodes that are graph-aware, and have been successfully used in downstream learning tasks including node classification, link prediction and graph classification. The construction of GCNs falls into two categories: spatial-based and spectral-based. Spatial-based GCNs are conveniently described as Message Passing Neural Networks (MPNNs) detailing the steps for aggregating information from neighbor graph nodes. They adopt a local view of the graph structure around each node and are straightforward to describe and lightweight to compute; however, they also need local customizations to enhance the performance of the representations they produce for downstream learning tasks. Spectral-based GCNs originate in graph signal processing perspectives. They are based on the graph Laplacian, so they inherently adopt a global graph view. However, they incur more computational cost, typically addressed by approximating their convolutional filter.

In Machine Learning (ML), entities of interest are typically encoded as points in a latent vector space (embeddings) for further processing. In particular, node embeddings is the starting point for applying ML methods on networks/graphs (graph ML) and GNNs are the workhorses for computing them. Their commonly computed node embeddings preserve some notion of similarity of the node to its neighbors. However, these node embeddings are agnostic to the direction of the edges between nodes in a directed graph: the embeddings do not carry information that differentiates the node when serving as the source or as the target of a directed edge. This can result in severe information loss when processing directed graphs in ML applications. Many graphs are directed (citation graphs, road networks, gene regulatory networks, causal graphs) and hence it becomes valuable to faithfully represent the direction of the flow of information over them—being able to hop only from node A to node B, with the reverse direction explicitly prohibited. Not capturing this important aspect in our node representations could irreparably impact graph analytics results.

One dimensional Weisfeiler-Leman (1-WL) algorithm is a well-studied approach for assigning distinct labels to the nodes of undirected, unweighted graphs with different topological roles Weisfeiler and Leman (1968). Given adjacency information in the form of neighborhood lists [symbol] (i)=[k: i [symbol] k∨k [symbol] i], ∀i∈[0, n), 1-dim WL iteratively updates a node's label by computing a bijective hash of its neighbors' labels, and mapping this to a unique label. The procedure terminates when the hash-and-map procedure stabilizes.

Graph Convolutional Networks (GCNs) suggest convolution operators for graph signals defined over graph nodes. Following the early analysis in Hammond et al. (2011) and the expansions in Defferrard et al. (2016), GCNs were particularly popularized by Kipf et al., Kipf and Welling (2016a). In particular, the work in Kipf and Welling (2016a) focused on undirected, unweighted graphs, such that the adjacency matrices are symmetric and binary. Each node i is initially assumed encoded by a k=k₀ dimensional vector xi, so all node encodings can be collected in an n×k matrix X=X⁽⁰⁾. The goal is to transform the node embeddings so that a downstream task such as node classification is more accurate.

The proposed transformation contains a succession of graph convolutional layers of the form:

$$\\ {Z}^{{}_{} ( t )} ← {\tilde{D}}^{- \frac{1}{2}} \tilde{A} {\tilde{D}}^{- \frac{1}{2}} {X}^{{}_{} ( t )} {W}^{{}_{} ( t )}$$

interspersed with nonlinear layers, like ReLU and/or softmax. The quantity W^{(t)} is a learnable kₜ×kₜ₊₁ matrix of weights for the t^{th} graph convolutional layer (t=0, 1, . . . ). The algorithm in Kipf and Welling (2016a) implements the transformation of the original encodings X:Z←softmax(ÂReLU(ÂXW⁽⁰⁾)W⁽¹⁾), where

$$\\ \hat{A} := {\tilde{D}}^{- \frac{1}{2}} \tilde{A} {\tilde{D}}^{- \frac{1}{2}} .$$

In Morris et al. (2019) the connection of 1-WL to 1-GNNs is explored. Their basic 1-GNN model assumes the form:

$$\\ {f}^{{}_{} ( t )} ( v ) = σ ( {f}^{{}_{} ( t - 1 )} ( v ) \cdot {W}_{1}^{{}_{} ( t )} + {\sum }_{w ∈ N ( v )} {f}^{{}_{} ( t - 1 )} ( w ) \cdot {W}_{2}^{{}_{} ( t )} )$$

In this, f^{(t)}(v), which is the row feature vector of node v at layer t>0, is computed by aggregating its feature vector and the feature vectors of its neighbors at the previous layer t−1, after first multiplying them respectively by parameter matrices W₁^{(t)} and W₂^{(t)}. It follows GCNs are 1-GNNs. These results establish the connection of 1-WL to 1-GNNs 3:

[Theorem 1 in Morris et al. (2019)] For all t≥0 and for all choices of weights W^{(t)} (W₁^{(t′)}, W₂^{(t′)})_{t′≤t}, coloring cₗ^{(t)} refines encoding f^{(t)}:cₗ^{(t)} [symbol] f^{(t)}. This means that for any nodes u, w in Gₛₜ, cₗ^{(t)}(u)=cₗ^{(t)}(w) implies f^{(t)}(u)=f^{(t)}(w).

[Theorem 2 in Morris et al. (2019)] For all t≥0 there exists a sequence of W^{(t)} and a 1-GNN architecture such that the colorings and the encodings are equivalent: cₗ^{(t)}≡f^{(t)} (i.e. cₗ^{(t)} [symbol] f^{(t)} and f^{(t)} [symbol] cₗ^{(t)}).

### SUMMARY

Embodiments of this disclosure include a directed graph autoencoder device that includes one or more memories and a processor coupled to the one or more memories and configured to implement a graph convolutional layer. The graph convolutional layer comprises a plurality of nodes and is configured to generate transformed dual vector representations by applying a source weight matrix and a target weight matrix to input dual vector representations of the plurality of nodes. The input dual vector representations comprise, for each node of the plurality of nodes, a source vector representation that corresponds to the node in its role as a source and a target vector representation that corresponds to the node in its role as a target. The graph convolutional layer is further configured to scale the transformed dual vector representations to generate scaled transformed dual vector representations. The graph convolutional layer is further configured to perform message passing using the scaled transformed dual vector representations.

In some embodiments of the directed graph autoencoder device, the graph convolutional layer is further configured to scale the transformed dual vector representations by applying, for each node of the plurality of nodes, different parameters to outdegrees and indegrees of the node.

In some embodiments of the directed graph autoencoder device, the graph convolutional layer is further configured to perform the message passing at least in part by sending, by each node of the plurality of nodes, a respective pair of the scaled transformed dual vector representations that corresponds to the node.

In some embodiments of the directed graph autoencoder device, the graph convolutional layer is further configured to further perform the message passing by sending, by each node of the plurality of nodes: a scaled transformed source vector representation of the respective pair of the scaled transformed dual vector representations that corresponds to the node to one or more respective first nodes, wherein the one or more respective first nodes correspond to j1∈ [symbol] (i), wherein j1 represents the one or more respective first nodes, [symbol] (i)= [symbol] (i)∪{i}, i represents the node, and [symbol] (i) represents a first set of nodes of the plurality of nodes that that the node points to; and a scaled transformed target vector representation of the respective pair of the scaled transformed dual vector representations that corresponds to the node to one or more respective second nodes, wherein the one or more respective second nodes correspond to j2∈ [symbol] (i), wherein j2 represents the one or more respective first nodes, [symbol] (i)= [symbol] (i)∪{i}, i represents the node, and [symbol] (i) represents a second set of nodes of the plurality of nodes that point to node.

In some embodiments of the directed graph autoencoder device, the graph convolutional layer is further configured to generate aggregated dual vector representations by aggregating, for each node of the plurality of nodes, corresponding scaled transformed vector representations of the scaled transformed dual vector representations that are received by the node, wherein the aggregated dual vector representations comprise a respective aggregated source vector representation for each node of the plurality of nodes and a respective aggregated target vector representation for each node of the plurality of nodes.

In some embodiments of the directed graph autoencoder device, the graph convolutional layer is further configured to generate layer output vector representations by scaling the aggregated dual vector representations.

In some embodiments of the directed graph autoencoder device, the processor is further configured to implement an activation function that is configured to apply an activation function to the layer output vector representations to generate encoder output vector representations.

In some embodiments of the directed graph autoencoder device, the processor is further configured to implement a decoder configured to determine updated weight matrices by decoding the encoder output vector representations.

Embodiments of this disclosure include a computer-implemented autoencoding method implemented by an autoencoder device, wherein the computer-implemented autoencoding method includes: generating, by a graph convolutional layer comprising a plurality of nodes, transformed dual vector representations by applying a source weight matrix and a target weight matrix to input dual vector representations of the plurality of nodes, wherein the input dual vector representations comprise, for each node of the plurality of nodes, a source vector representation that corresponds to the node in its role as a source and a target vector representation that corresponds to the node in its role as a target; scaling, by the graph convolutional layer, the transformed dual vector representations to generate scaled transformed dual vector representations; and performing, by the graph convolutional layer, message passing using the scaled transformed dual vector representations.

In some embodiments, the computer-implemented autoencoding method further includes scaling the transformed dual vector representations by applying, for each node of the plurality of nodes, different parameters to outdegrees and indegrees of the node.

In some embodiments, the computer-implemented autoencoding method further includes further performing the message passing at least in part by sending, by each node of the plurality of nodes, a respective pair of the scaled transformed dual vector representations that corresponds to the node.

In some embodiments, the computer-implemented autoencoding method further includes further performing the message passing by sending, by each node of the plurality of nodes: a scaled transformed source vector representation of the respective pair of the scaled transformed dual vector representations that corresponds to the node to one or more respective first nodes, wherein the one or more respective first nodes correspond to j1∈ [symbol] (i), wherein j1 represents the one or more respective first nodes, [symbol] (i)= [symbol] (i)∪{i}, i represents the node, and [symbol] (i) represents a first set of nodes of the plurality of nodes that that the node points to; and a scaled transformed target vector representation of the respective pair of the scaled transformed dual vector representations that corresponds to the node to one or more respective second nodes, wherein the one or more respective second nodes correspond to j2∈ [symbol] (i), wherein j2 represents the one or more respective first nodes, [symbol] (i)= [symbol] (i)∪{i}, i represents the node, and [symbol] (i) represents a second set of nodes of the plurality of nodes that point to node.

In some embodiments, the computer-implemented autoencoding method further includes generating, by the graph convolutional layer, aggregated dual vector representations by aggregating, for each node of the plurality of nodes, corresponding scaled transformed vector representations of the scaled transformed dual vector representations that are received by the node, wherein the aggregated dual vector representations comprise a respective aggregated source vector representation for each node of the plurality of nodes and a respective aggregated target vector representation for each node of the plurality of nodes.

In some embodiments, the computer-implemented autoencoding method further includes generating, by the graph convolutional layer, layer output vector representations by scaling the aggregated dual vector representations.

In some embodiments, the computer-implemented autoencoding method further includes applying an activation function to the layer output vector representations to generate encoder output vector representations.

In some embodiments, the computer-implemented autoencoding method further includes decoding the encoder output vector representations to determine updated weight matrices.

Embodiments of this disclosure include a non-transitory computer-readable medium configured to store computer-readable program instructions, that when executed by a processor, cause an autoencoder device to: generate transformed dual vector representations by applying a source weight matrix and a target weight matrix to input dual vector representations of a plurality of nodes, wherein the input dual vector representations comprise, for each node of the plurality of nodes, a source vector representation that corresponds to the node in its role as a source and a target vector representation that corresponds to the node in its role as a target; scale the transformed dual vector representations to generate scaled transformed dual vector representations; and perform message passing using the scaled transformed dual vector representations.

In some embodiments, the computer-readable program instructions, when executed by the processor, further cause the autoencoder device to scale the transformed dual vector representations by applying, for each node of the plurality of nodes, different parameters to outdegrees and indegrees of the node.

In some embodiments, the computer-readable program instructions, when executed by the processor, further cause the autoencoder device to perform the message passing at least in part by sending, by each node of the plurality of nodes, a respective pair of the scaled transformed dual vector representations that corresponds to the node.

In some embodiments, the computer-readable program instructions, when executed by the processor, further cause the autoencoder device to further perform the message passing by sending, by each node of the plurality of nodes: a scaled transformed source vector representation of the respective pair of the scaled transformed dual vector representations that corresponds to the node to one or more respective first nodes, wherein the one or more respective first nodes correspond to j1∈ [symbol] (i), wherein 1 represents the one or more respective first nodes, [symbol] (i) [symbol] (i)∪{i}, i represents the node, and [symbol] (i) represents a first set of nodes of the plurality of nodes that that the node points to; and a scaled transformed target vector representation of the respective pair of the scaled transformed dual vector representations that corresponds to the node to one or more respective second nodes, wherein the one or more respective second nodes correspond to j2∈ [symbol] (i), wherein j2 represents the one or more respective first nodes, [symbol] (i)= [symbol] (i)∪{i}, i represents the node, and [symbol] (i) represents a second set of nodes of the plurality of nodes that point to node.

### BRIEF DESCRIPTION OF THE DRAWINGS

FIG. 1 is a block diagram view of an embodiment of an autoencoder device according to the present disclosure.

FIG. 2 is a flowchart showing an embodiment of a computer-implemented encoder method capable of being performed, at least in part, by the autoencoder device of FIG. 1.

FIG. 3 is a flowchart showing an embodiment of a computer-implemented autoencoder method capable of being performed, at least in part, by the autoencoder device FIG. 1.

FIG. 4 shows an illustrative block diagram of an example data processing system that can be applied to implement embodiments of the present disclosure.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an” and “the” are intended to include the plural forms as well, unless the context clearly indicates otherwise.

An engine as referenced herein may comprise of software components such as, but not limited to, computer-executable instructions, data access objects, service components, user interface components, application programming interface (API) components; hardware components such as electrical circuitry, processors, and memory; and/or a combination thereof. The memory may be volatile memory or non-volatile memory that stores data and computer executable instructions. The computer-executable instructions may be in any form including, but not limited to, machine code, assembly code, and high-level programming code written in any programming language. The engine may be configured to use the data to execute one or more instructions to perform one or more tasks.

Embodiments of the disclosure include devices, systems, methods, and/or computer-readable mediums that include a novel family of GNN architectures (DiGAEs: Directed Graph Auto-encoders) for computing a pair of vector representations (also referred to as vector encodings) for each node in a directed network. The two vectors separately capture the dual role of the node serving as either the source or the target in its incident directed links. We use these encoding vector pairs for reconstructing the directed network structure. Computing our direction-aware pair encodings is fast, and we provide empirical evidence that the reconstruction quality is consistently superior, in area under the receiver operating characteristic (ROC) curve (AUC) and advanced precision (AP) metrics, over typical baseline node embedding methods and directed graph datasets.

Throughout this disclosure, we use the following variables to describe the graph, graph nodes, their vector representations, graph edges, adjacency matrices, and so on as explained in this paragraph. The dependencies of a network are described as a directed graph G(V, E, w), i.e., a weighted dependency graph. Here V is the set of n=|V| graph nodes and E={(i,j)∈V×V: i [symbol] j} is the set of its m=|E| directed edges, expressed as node pairs. Finally w:V∈V→ [symbol] is the edge weight function, with w(i,j) being a scalar capturing the “strength” of the dependency i [symbol] j iff (i,j)∈E—and vanishing otherwise. Following a linear algebra perspective, we will represent G(V, E, w) as an n×n sparse, weighted, adjacency matrix A. This matrix has m non-vanishing entries and its (i,j) entry is set equal to the respective weight w(i,j), i.e., A[i,j]=w(i,j). Throughout the rest of this paper, we use [symbol] (i)= [symbol] (i)∪{i}( [symbol] (i)= [symbol] (i)∪{i}) and deg⁺(i)| [symbol] (i)|(deg⁻(i)=| [symbol] (i)|), to denote the neighbor node sets of the outgoing (incoming) edges and outgoing (incoming) degrees of a node i—including itself. Analogously, the corresponding diagonal matrices with the outdegrees (indegrees) along their diagonal will be denoted as \tilde{D}⁺(\tilde{D}⁻), where we top with a tilde mark the names of adjacency matrices with added self-links. Note that for undirected, unweighted graphs, the corresponding adjacency matrices are symmetric and binary, i.e., \tilde{D} is a diagonal matrix where \tilde{d}ᵢᵢ is the original degree of node i increased by 1 (because of the added self-link).

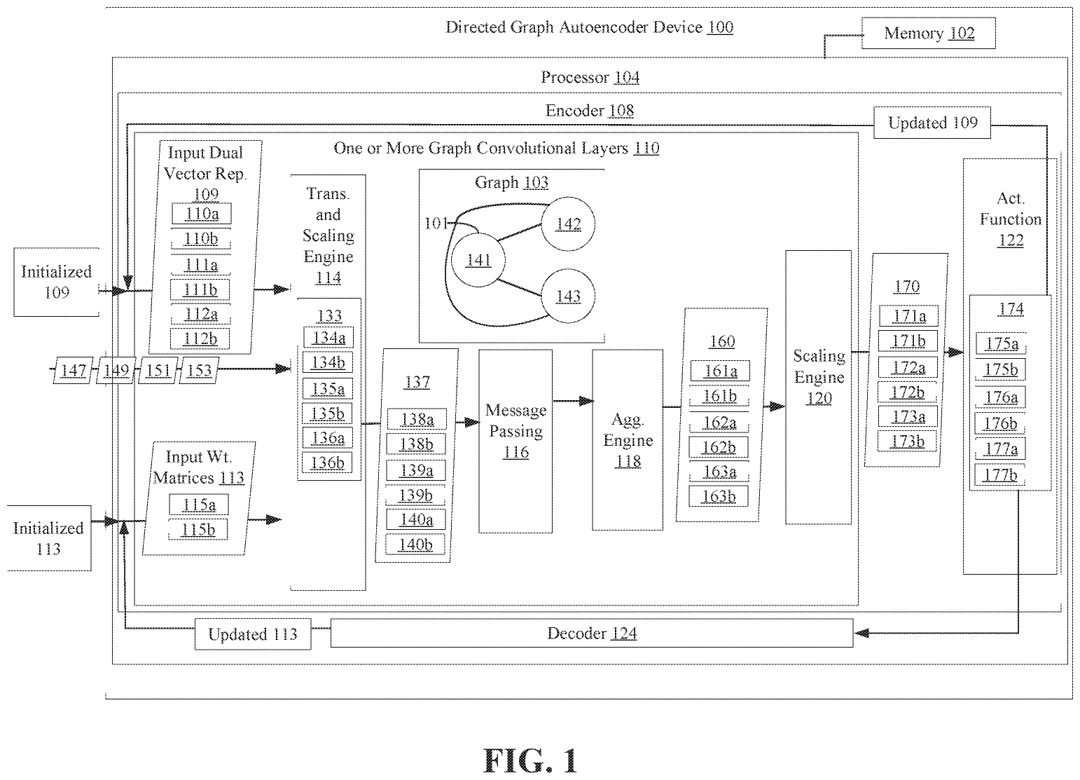

FIG. 1 illustrates a diagram of an example autoencoder device 100 that implements a graph neural network configured to use dual vector representations (for a plurality of nodes 101 of a graph 103) during message passing. The graph 103 illustrated in FIG. 1 illustrates the plurality of nodes 101 as including three nodes 141, 142, and 143. However, this is merely an example, and the plurality of nodes 101 may include more than three nodes or less than three nodes.

The example autoencoder device 100 includes a memory 102 and a processor 104 coupled to the memory 102.

The processor 104 includes an encoder 108 comprising one or more graph convolutional layers 110, an activation function 122, and a decoder 124. Although FIG. 1 illustrates an autoencoder device 100, it is noted that embodiments of this disclosure may be directed to a device that implements the one or more graph convolutional layers 110, the encoder 108 as a whole, or to the autoencoder device 100 as a whole.

Each graph convolutional layer of the one or more graph convolutional layers 110 includes (or receives as input) input dual vector representations 109, input weight matrices 113, a transformation and scaling engine 114, a message passing 116, an aggregation engine 118, and a scaling engine 120, and determines a pair of output vector representations for each node of the plurality of nodes 101 according to Algorithm 1. In other words, each graph convolutional layer of the one or more graph convolutional layers 110 implements Algorithm 1.

Algorithm 1

| | |
|---|---|
| Input: sᵢ, tᵢ; [symbol] (i), [symbol] (i); Wₛ, W_{T}; α, β | Line 1 |

Set: [symbol] (i) := [symbol] (i) ∪ {i} and deg ⁺(i) := | [symbol] (i)|; [symbol] − (i) :=

| | |
|---|---|
| [symbol] (i) ∪ {i} and deg ⁻(i) := \| [symbol] (i)\| | Line 2 |
| Transform: sᵢ ← W_{S}^{T}sᵢ; tᵢ ← W_{T}^{T}tᵢ; | Line 3 |
| $Scale : {s}_{i} ← \frac{1}{{( {deg}^{+} ( i ) )}^{β}} {s}_{i} ; {t}_{i} ← \frac{1}{{( {deg}^{-} ( i ) )}^{α}} {t}_{i}$ | Line 4 |
| Send: send (sᵢ, j) to all nodes j ∈ [symbol] (i); send(tᵢ, j) to | Line 5 |
| all nodes j ∈ [symbol] (i) | |
| Receive: sⱼ ← receive(j) from all nodes j ∈ [symbol] (i); tⱼ ← | |
| receive(j) from all nodes j ∈ [symbol] (i) | Line 6 |
| Sum: sᵢ ← [symbol] ₍ᵢ₎tⱼ; tᵢ ← [symbol] ₍ᵢ₎sⱼ | Line 7 |
| $Scale : {s}_{i} ← \frac{1}{{( {deg}^{+} ( i ) )}^{β}} {s}_{i} ; {t}_{i} ← \frac{1}{{( {deg}^{-} ( i ) )}^{α}} {t}_{i}$ | Line 8 |
| Output: sᵢ, tᵢ | Line 9 |

During training, the processor 104 may be configured to perform multiple hops through the encoder 108 and decoder 124 to learn a model comprising model weight matrices. Each hop through the encoder 108 and decoder 124 implements the one or more graph convolutional layers 110, the activation function 122, and the decoder 124.

For example, in embodiments in which the one or more graph convolutional layers 110 include a single graph convolutional layer, a first hop implements the encoder 108 using initialized dual vector representations for each node of the plurality of nodes 101 (e.g., initialized source vector representations and initialized target vector representations for each node of the plurality of nodes 101) and initialized weight matrices to determine first encoder output source vector representations and first encoder output target vector representations for each node of the plurality of nodes 101 that are input to the decoder 124, and the decoder 124 processes the first encoder output source vector representations and first encoder output target vector representations to determine first updated weight matrices. A second hop implements the encoder 108 using the initialized source vector representations and initialized target vector representations (used in the first hop) and the first updated weight matrices (output from the first hop) to determine second encoder output source vector representations and second encoder output target vector representations (for each node of the plurality of nodes 101) that are input to the decoder 124, and the decoder 124 processes the second encoder output source vector representations and encoder output target vector representations for each node of the plurality of nodes 101 to determine second updated weight matrices.

As another example, in embodiments in which the one or more graph convolutional layers 110 includes two graph convolutional layers, a first hop implements a first graph convolutional layer of the encoder 108 using initialized source vector representations and initialized target vector representations (for each node of the plurality of nodes 101) and first initialized weight matrices (e.g., a pair of initialized weight matrices including a first initialized source weight matrix and a first initialized target weight matrix) to determine first encoder output source vector representations and first encoder output target vector representations (for each node of the plurality of nodes 101), and then implements a second graph convolutional layer of the encoder 108 using the first encoder output source vector representations and first encoder output target vector representations (for each node of the plurality of nodes 101) and second initialized weight matrices (e.g., a second pair of initialized weight matrices including a second initialized source weight matrix and a second initialized target weight matrix) to determine second encoder output source vector representations and second encoder output target vector representations (for each node of the plurality of nodes 101) that are input to the decoder 124, and the decoder 124 processes the second encoder output source vector representations and the second encoder output target vector representations to determine first updated weight matrices (e.g., two pairs of weight matrices including a first pair of updated weight matrices and a second pair of updated weight matrices). A second hop implements the first graph convolutional layer of the encoder 108 using the initialized source vector representations and target vector representations (for each node of the plurality of nodes 101) and the first pair of updated weight matrices (e.g., a first updated source weight matrix and a first updated target weight matrix) to determine third encoder output source vector representations and third encoder output target vector representations (for each node of the plurality of nodes 101), and then implements the second graph convolutional layer of the encoder 108 using the third encoder output source vector representations and target vector representations and the second pair of updated weight matrices (e.g., a second updated source weight matrix and a second updated target matrix) to determine fourth encoder output source vector representations and fourth encoder output target vector representations (for each node of the plurality of nodes 101) that are input to the decoder 124, and the decoder 124 processes the fourth encoder output source vector representations and fourth encoder output target vector representations to determine second updated weight matrices.

The transformation and scaling engine 114 is configured to receive input dual vector representations 109, input weight matrices 113, [symbol] (i) 147, [symbol] (i) 149, a first scaling parameter (α) 151, and a second scaling parameter (β) 153.

The input dual vector representations 109 include pairs of vector representations (an input source vector representation and an input target vector representation), where each pair of the vector representations corresponds to a respective node of the plurality of nodes 101 and includes a source vector representation and a target vector representation. The source vector representation corresponding to a node captures the role of the node as a source of directed links, and the target vector representation corresponding to the node captures the role of the node as a target of directed links.

As an example in which the plurality of nodes 101 comprise three nodes (e.g., the nodes 141, 142, and 143), the input dual vector representations 109 include an input source vector representation 110a for the node 141, an input target vector representation 110b for the node 141, an input source vector representation 111a for the node 142, an input target vector representation 111b for the node 142, an input source vector representation 112a for the node 143, and an input target vector representation 112b for the node 143.

For an initial hop through the encoder 108, a first convolutional layer (or the single convolutional layer when the one or more graph convolutional layers 110 comprise a single convolutional layer) of the one or more graph convolutional layers 110, the input dual vector representations 109 are initialized using any technique. For each subsequent implementation of the one or more graph convolutional layers 110, the input dual vector representations 109 are the encoder output vector representations output by the activation function 122 of a preceding graph convolutional layer.

For each graph convolutional layer of the one or more graph convolutional layers 110, the transformation and scaling engine 114 for the graph convolutional layer is configured to transform the input dual vector representations 109 of the graph convolutional layer using a pair (e.g., a source weight matrix and a target weight matrix) of one or more (depending on whether each hop employs a single graph convolutional layer or multiple graph convolutional layer) pairs of input weight matrices 113 for each graph convolutional layer of a hop according to Line 3 of Algorithm 1 to generate transformed dual vector representations 133. The one or more input weight matrices 113 include one or more input source weight matrices 115a and one or more input target weight matrices 115b.

In embodiments in which the autoencoder device 100 uses a single graph convolutional layer during each hop, the one or more pairs of input weight matrices 113 (for a hop) include one pair of input weight matrices 113, wherein the one pair of weight matrices includes an input source weight matrix 115a and an input target weight matrix 115b. In embodiments in which the autoencoder device 100 uses multiple graph convolutional layers during each hop, the one or more pairs of input weight matrices 113 (for a hop) include multiple pairs of input weight matrices 113 (where a quantity of the multiple pairs corresponds to a quantity of the one or more graph convolutional layers 110), wherein the multiple pairs of weight matrices includes one or more input source weight matrices 115a and one or more input target weight matrices 115b. As an example, when the one or more graph convolutional layers 110 per hop include two graph convolutional layers, the one or more input source matrices 115a include two input source weight matrices and two input target weight matrices, where a first one of the two input source weight matrices and a first one of the two input target weight matrices is used during a first graph convolutional layer of a hop, and a second one of the two input source weight matrices and a second one of the two target weight matrices is used during a second graph convolutional layer of the hop.

For an initial hop through the encoder 108, the one or more pairs of input weight matrices 113 are initialized using any technique (e.g., via randomization). For each subsequent hop, the one or more pairs of input weight matrices 113 are the updated source and target weight matrices optimized by the output by the decoder 124 in the preceding hop.

Using the example graph 103 illustrated in FIG. 1, the transformation and scaling engine 114 of a convolutional layer is configured to: (1) apply the transformation in Line 3 of Algorithm 1 to the input source vector representation 110a for the node 141 using the one or more input source weight matrices 115a for the node 141 to generate a transformed source vector representation 134a for the node 141; (2) apply the transformation in Line 3 of Algorithm 1 to the input target vector representation 110b for the node 141 using the one or more input target weight matrices 115b for the node 141 to generate a transformed target vector representation 134b for the node 141; (3) apply the transformation in Line 3 of Algorithm 1 to the input source vector representation 111a for the node 141 using the one or more input source weight matrices 117a for the node 142 to generate a transformed source vector representation 135a for the node 142; (4) apply the transformation in Line 3 of Algorithm 1 to the input target vector representation 111b for the node 142 using the one or more input target weight matrices 117b for the node 142 to generate a transformed target vector representation 135b for the node 142; (5) apply the transformation in Line 3 of Algorithm 1 to the input source vector representation 112a for the node 143 using the one or more input source weight matrices 117a for the node 143 to generate a transformed source vector representation 136a for the node 143; and (6) apply the transformation in Line 3 of Algorithm 1 to the input target vector representation 112b for the node 142 using the one or more input target weight matrices 117b for the node 143 to generate a transformed target vector representation 136b for the node 143.

For each graph convolutional layer of the one or more graph convolutional layers 110, the transformation and scaling engine 114 for the graph convolutional layer is further configured to scale the transformed dual vector representations 133 determined during implementation of the graph convolutional layer to generate scaled transformed dual vector representations 137 according to Line 4 of Algorithm 1. Each graph convolutional layer is configured to scale the transformed dual vector representations 133 by applying, for each node of the plurality of nodes 101, different parameters (e.g., a first parameter 151 and a second parameter 153) to outdegrees and indegrees of the node. The first parameter 151 and the second parameter 153 (e.g., in Line 4 of Algorithm 1) are tunable parameters corresponding to α and β, respectively, in Algorithm 1 and are for weighting the degrees in message passing. The first parameter 151 and the second parameter 153 may be tuned using any hyperparameter optimization technique, such as grid search.

Varying the first parameter 151 and the second parameter 153 modifies the spectrum (singular values) of multiplication matrices Â, Â^{T}. In particular for smaller parameter values, the scaling role of the node degrees d is supressed (and in the limit of 0 it vanishes: 1/d⁰=1), and the spectrum max shifts to larger values while for larger parameters the spectrum range shrinks. Spectrum shrinking will typically lead to smaller magnitudes for source and target encodings, and so the sigmoid function in the decoder 124 can fail to predict links: this is consistent with the particularly low performance metrics when both the first parameter 151 and the second parameter 153 are large. From the local smoothing perspective around a node i, smaller first parameters 151 (e.g., smaller α's) reinforce the role of “authority” nodes j pointed by i (i.e. nodes with large indegree deg⁻(j)) in updating source encoding sᵢ from tⱼ's (contributing terms analogous to

$$\\ \frac{1}{{{deg}^{-} ( j )}^{α}} {t}_{j} ) .$$

Similarly, smaller second parameters 153 (e.g., smaller β's) reinforce the role of “hub” nodes j pointing to i (i.e. nodes with large outdegree deg⁺(j)) in updating target encoding tᵢ from sⱼ's (contributing terms analogous to

$$\\ \frac{1}{{{deg}^{+} ( j )}^{β}} {s}_{j} ) .$$

Using the example graph 103 illustrated in FIG. 1, the transformation and scaling engine 114 of a convolutional layer is configured to: (1) apply the scaling in Line 4 of Algorithm 1 to the transformed source vector representation 134a for the node 141 to generate a scaled transformed source vector representation 138a for the node 141; (2) apply the scaling in Line 4 of Algorithm 1 to the transformed target vector representation 134b for the node 141 to generate a scaled transformed target vector representation 138b for the node 141; (3) apply the scaling in Line 4 of Algorithm 1 to the transformed source vector representation 135a for the node 142 to generate a scaled transformed source vector representation 139a for the node 142; (4) apply the scaling in Line 4 of Algorithm 1 to the transformed target vector representation 135b for the node 142 to generate a scaled transformed target vector representation 139b for the node 142; (5) apply the scaling in Line 4 of Algorithm 1 to the transformed source vector representation 136a for the node 143 to generate a scaled transformed source vector representation 140a for the node 143; and (6) apply the scaling in Line 4 of Algorithm 1 to the transformed target vector representation 136b for the node 143 to generate a scaled transformed target vector representation 140b for the node 143.

For each graph convolutional layer of the one or more graph convolutional layers 110, the message passing 116 for the graph convolutional layer comprises each node sending its corresponding scaled transformed source vector representation and scaled transformed target vector representation to one or more other nodes according to Line 5 in Algorithm 1. As an example, for each graph convolutional layer of the one or more graph convolutional layers 110, the graph convolutional layer is configured to perform the message passing 116 by sending, by each node of the plurality of nodes: (1) a scaled transformed source vector representation of the respective pair of the scaled transformed vector representations that corresponds to the node to one or more respective first nodes, where the one or more respective first nodes correspond to j1 E [symbol] (i), where j1 represents the one or more respective first nodes, [symbol] (i)= [symbol] (i)∪{i}, i represents the node, and [symbol] +(i) represents the set of graph nodes that node i points to (including itself); and (2) a scaled transformed target vector representation of the respective pair of the scaled transformed vector representations that corresponds to the node to one or more respective second nodes, where the one or more respective second nodes correspond to j2∈ [symbol] (i), where j2 represents the one or more respective first nodes, [symbol] (i)= [symbol] (i)∪{i}, i represents the node, and [symbol] (i) represents the set of graph nodes that point to node i (including node i itself).

For each graph convolutional layer of the one or more graph convolutional layers 110, the aggregation engine 118 performs, for each node, aggregation using the received scaled transformed source vector representations and the received scaled transformed target vector representations received by the node during the message passing 116 of the graph convolutional layer to generate aggregated dual vector representations 160 according to Line 7 in Algorithm 1. The aggregated dual vector representations 160 include, for each node, a respective aggregated source vector representation and a respective aggregated target vector representation.

Using the example graph 103 illustrated in FIG. 1, the aggregation engine 118 of a convolutional layer is configured to: (1) apply the aggregation in Line 7 of Algorithm 1 for the node 141 to generate an aggregated source vector representation 161a for the node 141; (2) apply the aggregation in Line 7 of Algorithm 1 for the node 141 to generate an aggregated target vector representation 161b for the node 141; (3) apply the aggregation in Line 7 of Algorithm 1 for the node 142 to generate an aggregated source vector representation 162a for the node 142; (4) apply the aggregation in Line 7 of Algorithm 1 for the node 142 to generate an aggregated target vector representation 162b for the node 142; (5) apply the aggregation in Line 7 of Algorithm 1 for the node 143 to generate an aggregated source vector representation 163a for the node 143; and (6) apply the aggregation in Line 7 of Algorithm 1 for the node 143 to generate an aggregated target vector representation 163b for the node 143.

For each graph convolutional layer of the one or more graph convolutional layers 110, the scaling engine 120 for the graph convolutional layer is configured to scale the aggregated vector representations 160 during implementation of the graph convolutional layer according to Line 8 in Algorithm 1 to generate layer output vector representations 170.

Using the example graph 103 illustrated in FIG. 1, the layer output vector representations 170 include, for each node of the plurality of nodes 101, a layer output source vector representation and a layer output target vector representation. Using the example graph 103 illustrated in FIG. 1, the scaling engine 120 of a convolutional layer is configured to: (1) apply the scaling in Line 8 of Algorithm 1 for the node 141 to generate a layer output source vector representation 171a for the node 141; (2) apply the scaling in Line 8 of Algorithm 1 for the node 141 to generate a layer output target vector representation 171b for the node 141; (3) apply the scaling in Line 8 of Algorithm 1 for the node 142 to generate a layer output source vector representation 172a for the node 142; (4) apply the scaling in Line 8 of Algorithm 1 for the node 142 to generate a layer output target vector representation 172b for the node 142; (5) apply the scaling in Line 8 of Algorithm 1 for the node 143 to generate a layer output source vector representation 173a for the node 143; and (6) apply the scaling in Line 8 of Algorithm 1 for the node 143 to generate a layer output target vector representation 173b for the node 143.

Each graph convolutional layer of the one or more graph convolutional layers 110 is configured to provide the layer output vector representations 170 to the activation function 122. In some examples, the activation function 122 is a rectifier linear unit (ReLU) function. The activation function 122 applies an activation function to each vector representation of the layer output vector representations 170 to determine to generate encoder output vector representations 174. The encoder output vector representations 174 include, for each node of the plurality of nodes 101, an encoder output source vector representation and an encoder output target vector representation.

Using the example graph 103 illustrated in FIG. 1, the activation function 122 is configured to: (1) apply the activation function 122 to the layer output source vector representation 171a for the node 141 to generate an encoder output source vector representation 175a for the node 141; (2) apply the activation function 122 to the layer output target vector representation 171b for the node 141 to generate an encoder output target vector representation 175b for the node 141; (3) apply the activation function 122 to the layer output source vector representation 172a for the node 142 to generate an encoder output source vector representation 176a for the node 142; (4) apply the activation function 122 to the layer output target vector representation 172b for the node 142 to generate an encoder output target vector representation 176b for the node 142; (5) apply the activation function 122 to the layer output source vector representation 173a for the node 143 to generate an encoder output source vector representation 177a for the node 143; and (6) apply the activation function 122 to the layer output target vector representation 173b for the node 143 to generate an encoder output target vector representation 177b for the node 143.

For each hop, the encoder output source vector representations and encoder target vector representations determined for a last graph convolutional layer of the one or more graph convolutional layers 110 are provided to the decoder 124. The decoder 124 processes the received encoder output source and target vector representations to determine updated weight matrices that are used in a next hop through the encoder 108.

The decoder 124 determines the updated weight matrices using a function of the dot product of the corresponding encoder output source and target vectors for the nodes at two ends of the inks. For example, the adjacency matrix Ā determined by the decoder 124 may be represented using Equation 1, where σ is a sigmoid function, Z_{S} and Z_{T} are defined according to Equations 2 and 3 when the one or more graph convolutional layers 110 comprise two graph convolutional layers, and Z_{S} and Z_{T} are defined according to Equations 4 and 5 when the one or more graph convolutional layers 110 comprise one graph convolutional layer.

$$\\ \begin{matrix}\overline{A} = σ ( {Z}_{S} {Z}_{T}^{{}_{} ⊤} ) & Equation 1\end{matrix}$$

$$\\ \begin{matrix}{Z}_{S} = \hat{A} ReLU ( \hat{A} {}^{{}_{} ⊤} {S}^{{}_{} ( 0 )} {W}_{S}^{{}_{} ( 0 )} ) {W}_{T}^{{}_{} ( 1 )} & Equation 2\end{matrix}$$

$$\\ \begin{matrix}{Z}_{T} = \hat{A} {}^{{}_{} ⊤} ReLU ( \hat{A} {T}^{{}_{} ( 0 )} {W}_{T}^{{}_{} ( 0 )} ) {W}_{S}^{{}_{} ( 1 )} & Equation 3\end{matrix}$$

$$\\ \begin{matrix}{Z}_{S} = {S}^{{}_{} ( 1 )} = \hat{A} {}^{{}_{} ( 0 )} {T}^{{}_{} ( 0 )} {W}_{T}^{{}_{} ( 0 )} & Equation 4\end{matrix}$$

$$\\ \begin{matrix}{Z}_{T} = {T}^{{}_{} ( 1 )} = \hat{A} {}^{{}_{} ⊤} {S}^{{}_{} ( 0 )} {W}_{S}^{{}_{} ( 0 )} & Equation 5\end{matrix}$$

In the above Equations 1-5, Â is the transformed (by adding self-links) and scaled (by input and output degrees' powers with α and β as exponents) graph adjacency matrix, ReLU is the activation function 122, superscript T indicates matrix transposition, S⁽⁰⁾ is the matrix of input source encodings for all nodes as its rows, T⁽⁰⁾ is the matrix of input target encodings for all nodes as its rows, S⁽¹⁾ is the matrix of source encodings for all nodes as its rows as computed from the first convolutional layer, T⁽⁰⁾ is the matrix of target encodings for all nodes as its rows as computed from the first convolutional layer, W_{S}⁽⁰⁾ is the source weight matrix of the first convolutional layer, W_{T}⁽⁰⁾ is the target weight matrix of the first convolutional layer, W_{S}⁽¹⁾ is the source weight matrix of the second convolutional layer (if present), and W_{T}⁽¹⁾ is the target weight matrix of the second convolutional layer (if present).

The probability of whether there is a directed link from node i to node j is computed by applying the sigmoid function on the dot product of the source vector representation of node i and the target vector representation of node j (Equation 1).

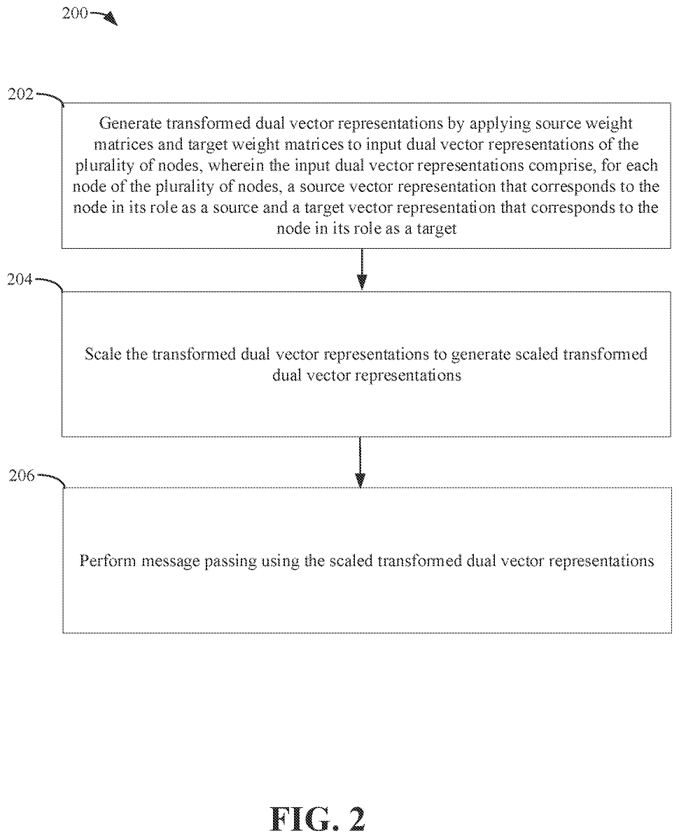

FIG. 2 illustrates an example flowchart of a computer-implemented encoder method 200 that is implemented by a graph convolutional layer of an autoencoder device. For example, the autoencoder device may correspond to the autoencoder device 100 of FIG. 1, and the graph convolutional layer may correspond to a graph convolutional layer of the one or more graph convolutional layers 110 of FIG. 1. The graph convolutional layer includes a plurality of nodes. For example, the graph convolutional layer may include the plurality of nodes 101 of FIG. 1.

The computer-implemented encoder method 200 of FIG. 2 includes, at 202, generating, by the graph convolutional layer, transformed dual vector representations by applying source weight matrices and target weight matrices to input dual vector representations of the plurality of nodes. The input dual vector representations include, for each node of the plurality of nodes, a source vector representation that corresponds to the node in its role as a source and a target vector representation that corresponds to the node in its role as a target. The input dual vector representations may be the input dual vector representations 109 (for a graph convolutional layer of the one or more graph convolutional layers 110) described above with reference to FIG. 1. The transformed dual vector representations are generated according to Line 3 of Algorithm as described above with reference to FIG. 1. For example, the transformed dual vector representations may correspond to the transformed dual vector representations 133 of FIG. 1.

The computer-implemented encoder method 200 of FIG. 2 further includes, at 204, scaling, by the graph convolutional layer, the transformed dual vector representations to generate scaled transformed dual vector representations. The scaled transformed dual vector representations may be generated by scaling the transformed dual vector representations (e.g., transformed dual vector representations 133 of FIG. 1) according to Line 4 of Algorithm 1.

The computer-implemented encoder method 200 of FIG. 2 further includes, at 206, performing message passing using the scaled transformed dual vector representations. The message passing may be performed according to Line 5 of Algorithm 1 as described above with reference to the message passing 116 of FIG. 1.

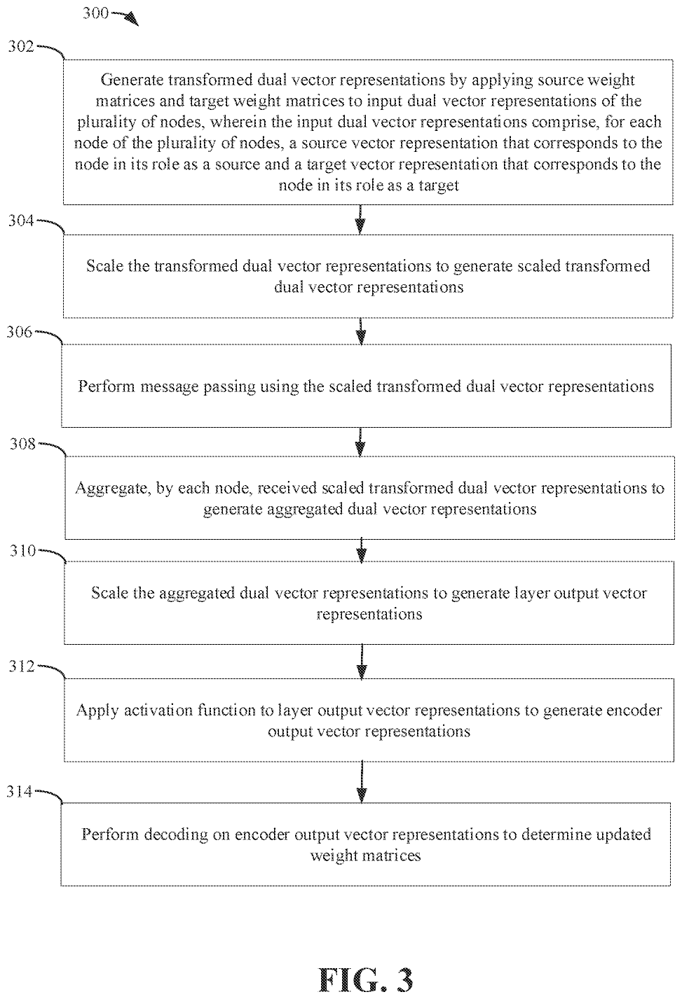

FIG. 3 illustrates an example flowchart of a computer-implemented autoencoder method 300 that is implemented by an autoencoder device that includes one or more graph convolutional layers that include a plurality of nodes. For example, the autoencoder device may correspond to the autoencoder device 100 of FIG. 1, and the one or more graph convolutional layers may correspond to a graph convolutional layer of the one or more graph convolutional layers 110 of FIG. 1. The graph convolutional layer includes a plurality of nodes. For example, the graph convolutional layer may include the plurality of nodes 101 of FIG. 1.

The computer-implemented autoencoding method 300 of FIG. 1 includes, at 302, generating, by the graph convolutional layer, transformed dual vector representations by applying source weight matrices and target weight matrices to input dual vector representations of the plurality of nodes. The input dual vector representations include, for each node of the plurality of nodes, a source vector representation that corresponds to the node in its role as a source and a target vector representation that corresponds to the node in its role as a target. The input dual vector representations may be the input dual vector representations 109 (for a graph convolutional layer of the one or more graph convolutional layers 110) described above with reference to FIG. 1. The transformed dual vector representations are generated according to Line 3 of Algorithm as described above with reference to FIG. 1. For example, the transformed dual vector representations may correspond to the transformed dual vector representations 133 of FIG. 1.

The computer-implemented autoencoding method 300 of FIG. 3 further includes, at 304, scaling, by the graph convolutional layer, the transformed dual vector representations to generate scaled transformed dual vector representations. The scaled transformed dual vector representations may be generated by scaling the transformed dual vector representations (e.g., transformed dual vector representations 133 of FIG. 1) according to Line 4 of Algorithm 1.

The computer-implemented autoencoding method 300 of FIG. 3 further includes, at 306, performing message passing using the scaled transformed dual vector representations. The message passing may be performed according to Line 5 of Algorithm 1 as described above with reference to the message passing 116 of FIG. 1.

The computer-implemented autoencoding method 300 of FIG. 3 further includes, at 308, aggregating, by each node, received scaled transformed dual vector representations to generate aggregated dual vector representations. For example, each node of the plurality of nodes may receive one or more received scaled transformed dual vector representations and generate aggregated dual vector representations according to Line 7 of Algorithm 1 as described above with reference to the aggregation engine 118 of FIG. 1. For example, the aggregated dual vector representations may correspond to the aggregated dual vector representations 160 of FIG. 1.

The computer-implemented autoencoding method 300 of FIG. 3 further includes, at 310, scaling the aggregated dual vector representations to generate layer output vector representations. For example, each node of the plurality of nodes may scale its aggregated dual vector representations according to Line 8 of Algorithm 1 as described above with reference to the scaling engine 120 of FIG. 1. For example, the layer output vector representations may correspond to the layer output vector representations 170 of FIG. 1.

The computer-implemented autoencoding method 300 of FIG. 3 further includes, at 312, applying an activation function to the layer output vector representations to generate encoder output vector representations. For example, the activation function may be applied as described above with reference to the activation function 122 of FIG. 1. For example, the encoder output vector representations may correspond to the encoder output vector representations 174 of FIG. 1.

The computer-implemented autoencoding method 300 of FIG. 3 further includes, at 314, perform decoding on encoder output vector representations to determine updated weight matrices. For example, the decoder 124 of FIG. 1 may receive the encoder output vector representations and decode the encoder output vector representations as described above with reference to the decoder 124 of FIG. 1.

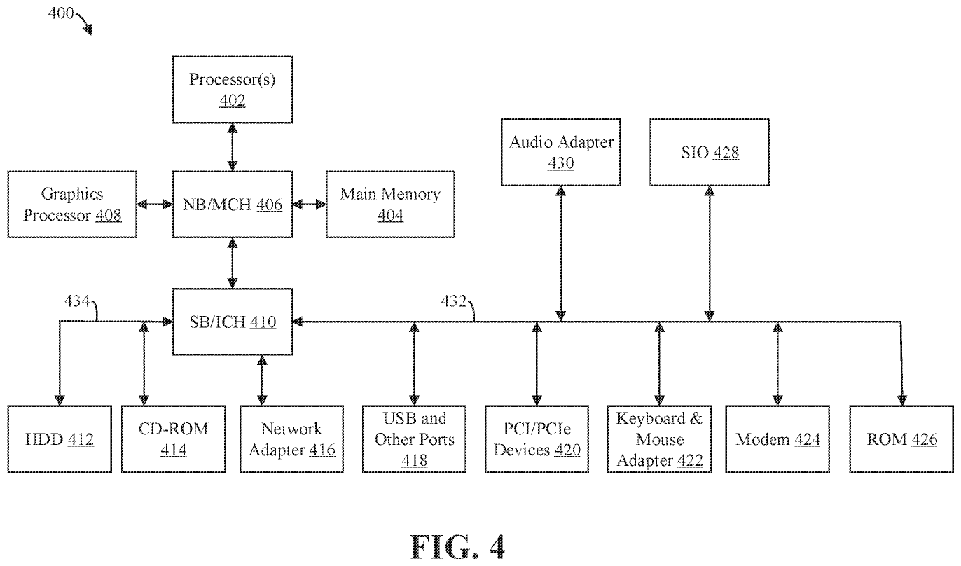

FIG. 4 is a block diagram of an example data processing system in which aspects of the illustrative embodiments may be implemented. Data processing system 400 is an example of a computer that can be applied to implement the autoencoder device 100 of FIG. 1 and in which computer usable code or instructions implementing the processes for illustrative embodiments of the present disclosure may be located. In one illustrative embodiment, FIG. 4 represents a computing device that implements the autoencoder device 100 of FIG. 1 augmented to include the additional mechanisms of the illustrative embodiments described hereafter.

In the depicted example, data processing system 400 employs a hub architecture including north bridge and memory controller hub (NB/MCH) 406 and south bridge and input/output (I/O) controller hub (SB/ICH) 410. Processor(s) 402, main memory 404, and graphics processor 408 are connected to NB/MCH 406. Graphics processor 408 may be connected to NB/MCH 406 through an accelerated graphics port (AGP).

In the depicted example, local area network (LAN) adapter 416 connects to SB/ICH 410. Audio adapter 430, keyboard and mouse adapter 422, modem 424, read only memory (ROM) 426, hard disc drive (HDD) 412, compact disc ROM (CD-ROM) drive 414, universal serial bus (USB) ports and other communication ports 418, and peripheral component interconnect (PCI) or PCI Express (PCIe) devices 420 connect to SB/ICH 410 through bus 432 and bus 434. PCI/PCIe devices may include, for example, Ethernet adapters, add-in cards, and personal computer (PC) cards for notebook computers. PCI uses a card bus controller, while PCIe does not. ROM 426 may be, for example, a flash basic input/output system (BIOS).

HDD 412 and CD-ROM drive 414 connect to SB/ICH 410 through bus 434. HDD 412 and CD-ROM drive 414 may use, for example, an integrated drive electronics (IDE) or serial advanced technology attachment (SATA) interface. Super I/O (SIO) device 428 may be connected to SB/ICH 410.

An operating system runs on processor(s) 402. The operating system coordinates and provides control of various components within the data processing system 400 in FIG. 4. In some embodiments, the operating system may be a commercially available operating system such as Microsoft® Windows 10®. An object-oriented programming system, such as the Java™ programming system, may run in conjunction with the operating system and provides calls to the operating system from Java™ programs or applications executing on data processing system 400.

In some embodiments, data processing system 400 may be, for example, an IBM® eServer™ System p® computer system, running the Advanced Interactive Executive (AIX®) operating system or the LINUX® operating system. Data processing system 400 may be a symmetric multiprocessor (SMP) system including a plurality of processors 402. Alternatively, a single processor system may be employed.

Instructions for the operating system, the object-oriented programming system, and applications or programs are located on storage devices, such as HDD 412, and may be loaded into main memory 404 for execution by processor(s) 402. The processes for illustrative embodiments of the present disclosure may be performed by processor(s) 402 using computer usable program code, which may be located in a memory such as, for example, main memory 404, ROM 426, or in one or more peripheral devices 412 and 414, for example.

A bus system, such as bus 432 or bus 434 as shown in FIG. 4, may include one or more buses. The bus system may be implemented using any type of communication fabric or architecture that provides for a transfer of data between different components or devices attached to the fabric or architecture. A communication unit, such as modem 424 or network adapter 416 of FIG. 4, may include one or more devices used to transmit and receive data. A memory may be, for example, main memory 404, ROM 426, or a cache such as found in NB/MCH 406 in FIG. 4.

The present disclosure may be a system, a method, and/or a computer program product at any possible technical detail level of integration. The computer program product may include a non-transitory computer-readable medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a ROM, an erasable programmable read only memory (EPROM) or Flash memory, a static RAM (SRAM), a portable CD-ROM, a digital video disc (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or eternal storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGS. illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A directed graph autoencoder device, comprising:
one or more memories; and
a processor coupled to the one or more memories and configured to implement a graph convolutional layer that comprises a plurality of nodes and that is configured to:
generate transformed dual vector representations by applying a source weight matrix and a target weight matrix to input dual vector representations of the plurality of nodes, wherein the input dual vector representations comprise, for each node of the plurality of nodes, a source vector representation that corresponds to the node in its role as a source and a target vector representation that corresponds to the node in its role as a target;
scale the transformed dual vector representations to generate scaled transformed dual vector representations; and
perform message passing using the scaled transformed dual vector representations.

2. The directed graph autoencoder device of claim 1, wherein the graph convolutional layer is further configured to scale the transformed dual vector representations by applying, for each node of the plurality of nodes, different parameters to outdegrees and indegrees of the node.

3. The directed graph autoencoder device of claim 2, wherein the graph convolutional layer is configured to perform the message passing at least in part by sending, by each node of the plurality of nodes, a respective pair of the scaled transformed dual vector representations that corresponds to the node.

4. The directed graph autoencoder device of claim 3, wherein the graph convolutional layer is configured to further perform the message passing by sending, by each node of the plurality of nodes:
a scaled transformed source vector representation of the respective pair of the scaled transformed dual vector representations that corresponds to the node to one or more respective first nodes, wherein the one or more respective first nodes correspond to j1∈ [symbol] (i), wherein j1 represents the one or more respective first nodes, [symbol] (i)= [symbol] (i)∪{i}, i represents the node, and [symbol] (i) represents a first set of nodes of the plurality of nodes that that the node points to; and
a scaled transformed target vector representation of the respective pair of the scaled transformed dual vector representations that corresponds to the node to one or more respective second nodes, wherein the one or more respective second nodes correspond to j2∈ [symbol] (i), wherein j2 represents the one or more respective first nodes, [symbol] (i)= [symbol] (i)∪{i}, i represents the node, and [symbol] (i) represents a second set of nodes of the plurality of nodes that point to node.

5. The directed graph autoencoder device of claim 1, wherein the graph convolutional layer is further configured to generate aggregated dual vector representations by aggregating, for each node of the plurality of nodes, corresponding scaled transformed vector representations of the scaled transformed dual vector representations that are received by the node, wherein the aggregated dual vector representations comprise a respective aggregated source vector representation for each node of the plurality of nodes and a respective aggregated target vector representation for each node of the plurality of nodes.

6. The directed graph autoencoder device of claim 5, wherein the graph convolutional layer is further configured to generate layer output vector representations by scaling the aggregated dual vector representations.

7. The directed graph autoencoder device of claim 6, wherein the processor is further configured to implement an activation function that is configured to apply an activation function to the layer output vector representations to generate encoder output vector representations.

8. The directed graph autoencoder device of claim 7, wherein the processor is further configured to implement a decoder configured to determine updated weight matrices by decoding the encoder output vector representations.

9. An computer-implemented autoencoding method implemented by an autoencoder device, wherein the computer-implemented autoencoding method comprises:
generating, by a graph convolutional layer comprising a plurality of nodes, transformed dual vector representations by applying a source weight matrix and a target weight matrix to input dual vector representations of the plurality of nodes, wherein the input dual vector representations comprise, for each node of the plurality of nodes, a source vector representation that corresponds to the node in its role as a source and a target vector representation that corresponds to the node in its role as a target;
scaling, by the graph convolutional layer, the transformed dual vector representations to generate scaled transformed dual vector representations; and
performing, by the graph convolutional layer, message passing using the scaled transformed dual vector representations.

10. The computer-implemented autoencoding method of claim 9, further comprising scaling the transformed dual vector representations by applying, for each node of the plurality of nodes, different parameters to outdegrees and indegrees of the node.

11. The computer-implemented autoencoding method of claim 10, further comprising further performing the message passing at least in part by sending, by each node of the plurality of nodes, a respective pair of the scaled transformed dual vector representations that corresponds to the node.

12. The computer-implemented autoencoding method of claim 11, further comprising further performing the message passing by sending, by each node of the plurality of nodes:
a scaled transformed source vector representation of the respective pair of the scaled transformed dual vector representations that corresponds to the node to one or more respective first nodes, wherein the one or more respective first nodes correspond to j1∈ [symbol] (i), wherein j1 represents the one or more respective first nodes, [symbol] (i)= [symbol] (i)∪{i}, i represents the node, and [symbol] (i) represents a first set of nodes of the plurality of nodes that that the node points to; and
a scaled transformed target vector representation of the respective pair of the scaled transformed dual vector representations that corresponds to the node to one or more respective second nodes, wherein the one or more respective second nodes correspond to j2∈ [symbol] (i), wherein j2 represents the one or more respective first nodes, [symbol] (i)= [symbol] (i)∪{i}, i represents the node, and [symbol] (i) represents a second set of nodes of the plurality of nodes that point to node.

13. The computer-implemented autoencoding method of claim 11, further comprising generating, by the graph convolutional layer, aggregated dual vector representations by aggregating, for each node of the plurality of nodes, corresponding scaled transformed vector representations of the scaled transformed dual vector representations that are received by the node, wherein the aggregated dual vector representations comprise a respective aggregated source vector representation for each node of the plurality of nodes and a respective aggregated target vector representation for each node of the plurality of nodes.

14. The computer-implemented autoencoding method of claim 13, further comprising generating, by the graph convolutional layer, layer output vector representations by scaling the aggregated dual vector representations.

15. The computer-implemented autoencoding method of claim 14, further comprising applying an activation function to the layer output vector representations to generate encoder output vector representations.

16. The computer-implemented autoencoding method of claim 15, further comprising decoding the encoder output vector representations to determine updated weight matrices.

17. A non-transitory computer-readable medium configured to store computer-readable program instructions, that when executed by a processor, cause an autoencoder device to:
generate transformed dual vector representations by applying a source weight matrix and a target weight matrix to input dual vector representations of a plurality of nodes, wherein the input dual vector representations comprise, for each node of the plurality of nodes, a source vector representation that corresponds to the node in its role as a source and a target vector representation that corresponds to the node in its role as a target;
scale the transformed dual vector representations to generate scaled transformed dual vector representations; and
perform message passing using the scaled transformed dual vector representations.

18. The non-transitory computer-readable medium of claim 17, wherein the computer-readable program instructions, when executed by the processor, further cause the autoencoder device to scale the transformed dual vector representations by applying, for each node of the plurality of nodes, different parameters to outdegrees and indegrees of the node.

19. The non-transitory computer-readable medium of claim 17, wherein the computer-readable program instructions, when executed by the processor, further cause the autoencoder device to perform the message passing at least in part by sending, by each node of the plurality of nodes, a respective pair of the scaled transformed dual vector representations that corresponds to the node.

20. The non-transitory computer-readable medium of claim 18, wherein the computer-readable program instructions, when executed by the processor, further cause the autoencoder device to further perform the message passing by sending, by each node of the plurality of nodes:
a scaled transformed source vector representation of the respective pair of the scaled transformed dual vector representations that corresponds to the node to one or more respective first nodes, wherein the one or more respective first nodes correspond to j1∈ [symbol] (i), wherein j1 represents the one or more respective first nodes, [symbol] (i)= [symbol] (i)∪{i}, i represents the node, and [symbol] (i) represents a first set of nodes of the plurality of nodes that that the node points to; and
a scaled transformed target vector representation of the respective pair of the scaled transformed dual vector representations that corresponds to the node to one or more respective second nodes, wherein the one or more respective second nodes correspond to j2∈ [symbol] (i), wherein j2 represents the one or more respective first nodes, [symbol] (i)= [symbol] (i)∪{i}, i represents the node, and [symbol] (i) represents a second set of nodes of the plurality of nodes that point to node.
